(19) United States
(12) Patent Application Publication
(10) Pub. No.: US 2002/0082888 A1
(43) Pub. Date: Jun. 27, 2002

(54) Business method for a marketing strategy

(76) Inventors: Andrew K. Graff, North Andover, MA (US); Paul S. Allen, Sudbury, MA (US); Mary M. Redington, Berlin, MA (US)

Correspondence Address: ST. ONGE STEWARD JOHNSTON & REENS, LLC, 986 BEDFORD STREET, STAMFORD, CT, 06905-5619, US

(21) Appl. No.: 10/014,697

(22) Filed: Dec. 11, 2001

Related U.S. Application Data
(60) Provisional application No. 60/254,826, filed on Dec. 12, 2000.

(51) Int. Cl. G06F 17/60

(52) U.S. Cl. 705/7; 705/10

(57) ABSTRACT

The invention relates to a method for an improved marketing strategy including the steps of providing a representation of how a business interacts with a customer, identifying differences between existing content being transmitted to a customer and a customer's expectation, and determining techniques a company uses to communicate to a customer.

### PRIORITY APPLICATAION

The present application claims the benefit, under 35 U.S.C. §119(e), of U.S. Provisional Patent Application No. 60/254,826, filed Dec. 12,2000.

### FIELD OF THE INVENTION

The invention relates to a method for providing an improved marketing strategy and, more particularly, a method for identifying an active role a company may play in improving a relationship with the company's customers.

### BACKGROUND OF THE INVENTION

Business growth, profitability, public offerings, and obtaining investors typically require attracting customers, whether they are companies or members of the general public. Generally, businesses grow and reap profits when revenues from customers are up. In addition, investors usually invest in businesses that successfully provide what customers desire. However, simply providing a high quality and/or desirable product or service may not be enough for a successful business because if consumers are unaware of a company's existence, the company will generally suffer no matter how wonderful the product/service it provides. Therefore, marketing a business' name and its strengths is one way of spurring growth and capital because consumers are made aware of the business and the advantages it may provide to them.

One known marketing method is to give away free samples of a product. Giving away free samples permits potential customers an opportunity, free of charge, to use the product. While this method causes a manufacturer to initially incur costs in giving away merchandise, the theory is that some of the recipients will eventually begin to buy the products after realizing, based on the free samples, the advantages the products provide. It is expected these customers will make up for the initial losses by later paying for the products. A disadvantage of this method is that companies must incur initial costs by giving products away. A second disadvantage is that there is no way for marketers to know if any later purchases are the result of products initially given away. This makes it a difficult to assess whether or not the marketing strategy is successful because, unless retailers survey customers who buy products, there is no way to account for their reasons for making a purchase.

Another known marketing method is to saturate the market with advertisements in the hopes that driving a brand name, trademark, or service mark into people's memory will cause them to buy the advertised products. Similarly, actively soliciting people through telemarketing is another way to saturate a market. Hiring personnel to visit malls, homes, or anywhere people gather in order to hand out brochures or questionnaires is a further method of active solicitation.

Generally, techniques for marketing a business vary among different types of businesses, such as pharmaceutical companies, which typically stress their products, versus baseball teams, which typically stress their players. A marketing strategy designed to illustrate long term effects of a drug in clinical laboratories usually is not a strategy conducive to elaborating a baseball player's awards and homerun streak. In addition, techniques for marketing a business vary among the varying target audiences. Age groups, income, parts of the country, parts of the world, and cultural background are just some of the numerous factors that may also affect techniques for marketing a business. For example, loud rock and roll music accompanying a description of a skateboard generally is not an advertising method commonly used when describing a retirement community for seniors. Identifying a desirable marketing strategy and delivering that strategy using a technique that is favorably received by customers are variables that a company typically wants to successfully determine. Hence, marketing may play a role in business growth and profitability. More specifically, the role a business plays in a way that affects a customer's quality of life may prove advantageous in a successful marketing strategy.

What is desired, therefore, is a method for identifying a desirable marketing strategy. What is also desired is a method for determining a technique for delivering a marketing strategy that is favorably received by an audience. What is further desired is a marketing strategy that identifies an active role a business may play to further a relationship with its customers.

### SUMMARY OF THE INVENTION

Accordingly, it is an object of the invention to provide a method for providing an improved marketing strategy.

It is another object of the invention to provide a method for determining a technique for delivering a marketing strategy that is likely to be favorably received by a customer.

Another object of the invention is to identify a role a business may play for actively furthering a relationship with its customers.

These and other objects of the invention are achieved by a method for an improved marketing strategy including the steps of providing a representation of how a business interacts with a customer, identifying differences between existing content being transmitted to a customer and a customer's expectation, and determining techniques a company uses to communicate to a customer.

In certain embodiments, the method further includes the step of determining limitations of communications between a business and a customer, determining a likelihood of capturing a customer's attention, surveying customers and prospective customers, and balancing measurable attributes with intangible attributes.

In other embodiments, the method further includes the step of identifying strategic opportunities in order to determine the environment in which to market the product selected from the group consisting of communications, strategic imperatives, positioning evolutions, competitive mappings, target audiences, value opportunities, branding permissions, and brand attribute imperatives.

In further embodiments, the method further includes the step of measuring a likelihood of success of the marketing strategy selected from the group consisting of polling, surveying, researching, qualifying, quantifying, and combinations thereof. Additionally, the method includes examining various levels of messaging and media for use in marketing communications and developing a tracking system in order to identify prospective customers,

In a more particular aspect of the invention, the step for providing a model of the company's operations includes the steps of examining a business' operations, examining a business' product being offered to a customer, examining the customer's reaction to the business, examining how the customer accesses the business, and formulating a marketing strategy based upon the model.

In a more particular aspect of the invention, the step for identifying differences between existing content being transmitted to a customer and a customer's expectation includes the steps of examining a message transmitted from a business to a customer, examining a customer's expectation, examining a customer's assessment of value associated with the transmitted message, surveying a customer, surveying a business' employee, identifying differences between the customer's opinion, the business' employee's opinion, and the transmitted message, and formulating a marketing strategy based upon the differences.

In a more particular aspect of the invention the step for determining a likelihood of the customer favorably receiving content includes the steps of examining content of communications between a business and a customer, examining the business' technique for conveying the content to the customer, and comparing the differences and formulating a marketing strategy based upon the examined content and technique.

The invention and its particular features and advantages will become more apparent from the following detailed description considered with reference to the accompanying drawings.

### BRIEF DESCRIPTION OF THE DRAWINGS

FIG. 1 depicts the method in accordance with the invention.

FIG. 2 more particularly depicts the step for identifying a business's role in furthering a relationship with a customer.

FIG. 3 depicts the step for developing a model of how a business interacts with a customer.

FIG. 4 depicts the step for identifying differences between existing content being transmitted to a customer and the customer's expectation.

FIG. 5 depicts the step for determining a likelihood of the customer favorably receiving content.

### DETAILED DESCRIPTION OF THE DRAWINGS

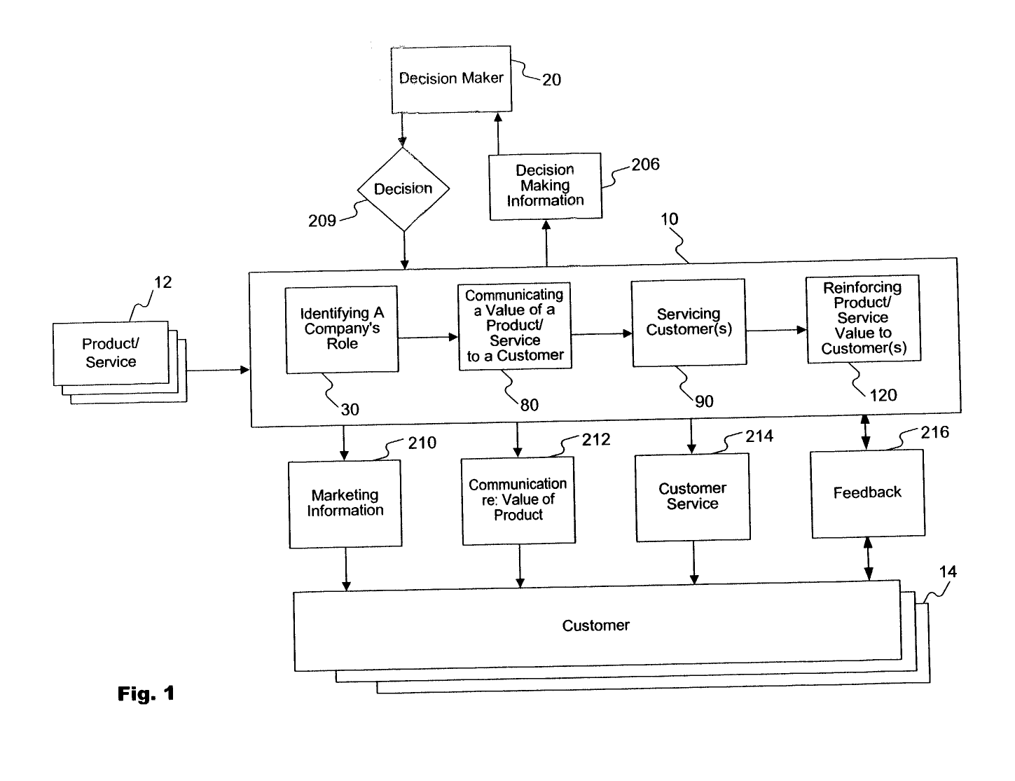

FIG. 1 depicts the business method in accordance with the invention. Business method 10 comprises identifying 30 a company's role in furthering a relationship between the company and customer, communicating 80 a value of product 12 to customer 14, servicing 90 the customer, and reinforcing 120 the value of product 12 to retain customer 14.

Product 12 is defined to be the item being marketed. In certain embodiments, product 12 is a good or plurality of goods. In other embodiments, product 12 is a service or plurality of services. Some businesses that market services, as opposed to products, include cleaning companies, law firms, physician offices, and the like.

A decision 204 as to how product 12 is to be marketed is determined by a decision maker 202. In certain embodiments, decision maker 202 is a person who makes the determination, or decision 204, as to identifying 30 a business' role, communicating 80 a value of product 12 to a customer, servicing 90 a customer, and/or reinforcing 120 product value to a customer. In certain other embodiments, decision maker 202 is a computer with software executing on the computer for receiving and processing data for making decision 204. The data, or decision making information 206, relates to product 12, identifying 30 a business' role, communicating 80 a value of product 12, servicing 90 a customer, reinforcing 120 product value, or any other type of information helpful to decision maker 202 to facilitate making a decision 204. Decision making information is sent, in some embodiments, by humans and, in other embodiments, transmitted automatically by an automated system.

Because decision 204 relates to one or more aspects of method 10, namely identifying 30 a company's role, communicating 80 a value of product 12 to a customer, servicing 90 a customer, or reinforcing 120 product value to a customer, customer 14 receives information related to any or all of the above mentioned areas, depending on what decision maker 202 determines suitable for customer 14 to receive. In certain embodiments, customer receives marketing information 210. In certain other embodiments, customer receives value 212 of product 12. Still, in certain other embodiments, customer 14 receives customer service 214. In other embodiments, customer 14 receives a combination of the above. Optionally, customer 14 provides feedback 216 so that decision maker 202 makes more informed decisions.

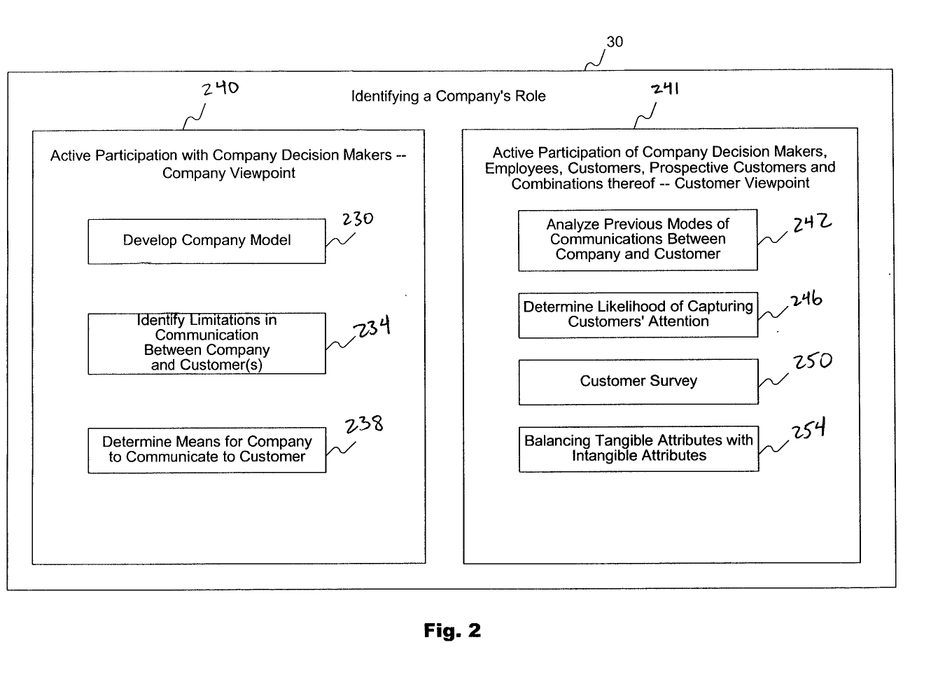

As shown in FIG. 2, identifying 30 a company's role in furthering a relationship between the company and customer includes active participation between a company and a company's customers.

Identifying 30 the company's role includes developing 230 a model, or representation, of the company's foundation, product 12, accessibility to its customers, and intended purchases of product 12. The model is a graphical representation of the company's business and how the company is reached by its customers. The model is a graph, table, map, or flowchart. The invention should not be limited to the manner in which a model is presented. One who is identifying 30 the business' role generally converses with the company's decision makers, such as directors, officers, managers, and the like, to obtain information in constructing the representation. Typical information is a business' plans for growth.

In other embodiments, developing 230 a representation includes examining a business' operations, examining a customer's reaction to the business, and examining how the business affects a customer's quality of life.

Developing 230 a model usually entails seeking answers to at least of one of the following questions: what is the foundation of the business; what is the business' process; what is the product/service; how do people access the business; and who is the intended purchasers of the product/service. The answers to these questions generally relate to what is known as the rational aspect of the business.

Identifying 30 a company's role in furthering a relationship between the company and customer also includes identifying 234 limitations in communications between a company and customer. This includes identifying gaps in communications and using these gaps as a basis for marketing opportunities. Identifying 234 limitations typically involve categorizing messages the company wants to send to a customer related to product 12. In certain embodiments, entails seeking answers to the following questions posed by an imaginary customer: what do I expect; what do I value; what irritates me about the company; and what is unimportant about the messages.

Identifying 234 limitations also includes surveying employees and, in certain embodiments, surveying customers regarding the company's messages. Identifying 234 limitations further involves analyzing differences between the customer's surveys, employee surveys, and/or responses to the above questions and identifying a marketing opportunity to overcome these differences, or limitations, Identifying 234 limitations focuses on the missing opportunities between company and customer.

Determining 238 the means by which the company communicates to the customer relates to examining the techniques used by the company to deliver the marketing strategy, value of product 12, messages, and the like, to the customer. The manner in which information is conveyed, regardless of content, is examined. Determining 238 the means by which the company communicates may involve altering previous techniques if found they do not positively further the relationship between company and customer.

In certain embodiments, method 10 requires decision makers participating in developing 230 a model, identifying 234 limitations, determining 238 techniques, and combinations thereof. Generally, method 10 obtains a company's viewpoint 240 with regard to identifying 30 a company's role.

Identifying 30 a company's role in furthering a relationship between the company and customer also includes analyzing 242 previous modes of communications between company and customer. Analyzing 242 previous modes relates to the way a value of product 12 had been communicated to the customer in the past, such as mailings, phone calls, emails, facsimiles, or in-person meetings. If previous communications had been by mail, suddenly phoning the customer may positively impress the customer. On the other hand, phoning the customer during dinner hours or late in the evening may hurt the relationship. Moreover, if previous communications had been by phone during early morning hours, the company should feel that calling the customer at such time in the future would be permissible. Therefore, analyzing 242 previous modes of communications between company and customer uncovers what is permissible and what is not. If there was a lack of historical communications, rectifying this is also involved in analyzing 242 the modes of communications.

Determining 246 a likelihood of capturing a customer's attention is based upon examining a host of factors that divert a customer's attention away from the company's messages, such as personal life, internal problems with the customer if the customer is another business, or communication problems if the customer is overseas. Determining 246 a likelihood of capturing the customer's attention examines these factors, among others, to arrive at a successful marketing strategy to market product 12 to the customer

Surveying 250 customers, which may overlap with identifying 234 limitations, which may also optionally include customer surveys, relates to obtaining customer's opinions regarding the company, value of product 12, need for product 12, and importance of product 12 to the customer. Surveying 250 uses all known and novel manners for extracting information from the customer.

Balancing 254 measurable attributes with intangible attributes relates to achieving a balance between attributes that can be quantified and attributes that are more theoretically determined because a proper balance contributes to a more successful marketing strategy.

Tangible attributes include company size, market share, performance history, ability to ship products in a timely manner, or any assets of the company that affect a company's role in furthering a relationship with a customer. Intangible attributes include a customer's viewpoint, trustworthiness, reliability, gut feeling, quality, or any assessments of the company that are typically difficult to quantify.

An imbalance having few intangible attributes may subject the company to competitive threats because there are few assessments, especially good assessments, by the public. Therefore, without a reputation among customers of the company, competitors will have better chances of stealing away those customers. An imbalance having few tangible attributes may impede a company's ability to develop a customer base. This is because a company having a low market share, poor service, and a poor performance history will have difficulty attracting customers.

In certain embodiments, the steps of analyzing 242 previous modes of communications, determining 246 a likelihood of capturing customers' attention, surveying 250 customers, and balancing 254 measurable attributes with intangible attributes require active participation between decision makers, employees, customers, and/or potential customers. Generally, method 10 obtains a customer's viewpoint 241 with regards to this discussion of identifying 30 a company's role.

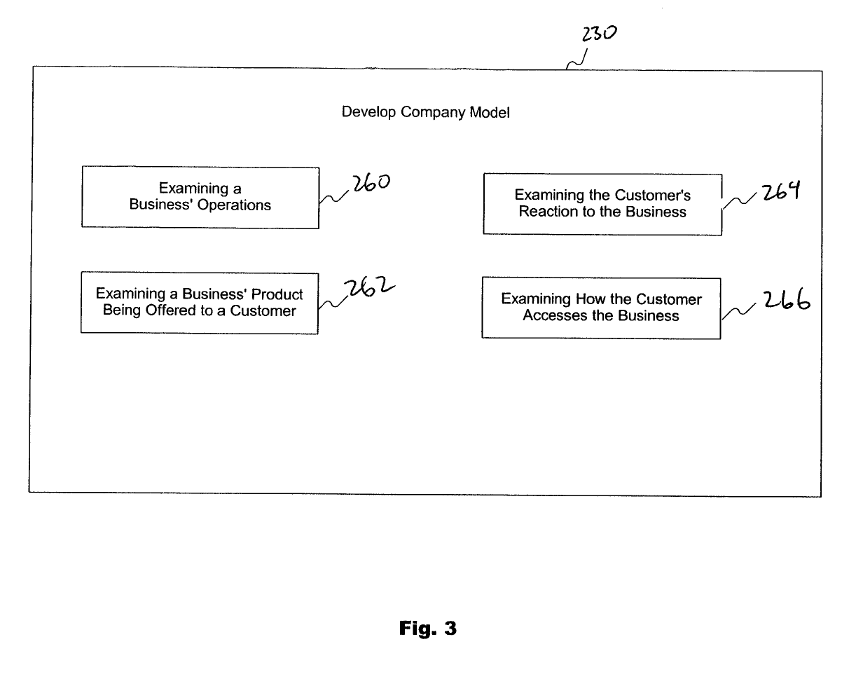

FIG. 3 more particularly depicts the step for developing 230 a model for the company. Steps for developing 230 the model include examining 260 a business' operations, such as determining if the company is a sales organization or one that generates consumer products or one that caters to the military. Different types of business may have operations unique to that type of business. Phones, Internet, mailings, and other communication mediums may be more vital to a sales organization that a company under contract with the government. Hence, examining 260 a business' operations is one step toward developing 230 a model.

Other steps include examining 262 a business' product, examining 264 the customer's reaction to the business, and examining 266 how customers access the business. For the reasons given above, different types of businesses in different trades have different products 12, customer bases, and ways customers get in contact with the business. These steps, among others, are some of the factors examined in developing 230 a model of how a company interacts with customers. The model serves as a flowchart for visualizing what the current operation of the business is and what the company's future road map may look like.

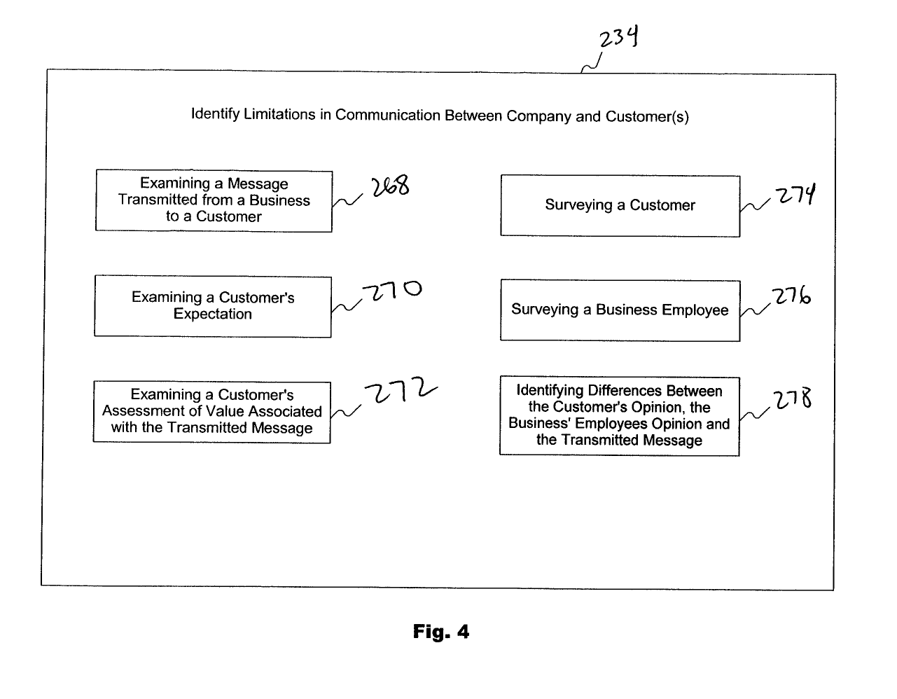

FIG. 4 more particularly depicts the step for identifying 234 limitations, or gaps, in communications between a company and customer. Generally, method 10 seeks to examine the current state of contact between company and customer and to uncover any weaknesses, or breakdowns, in communications. Method 10 then uses these gaps in communications as areas of the marketing strategy upon which to improve and, more specifically, uses these gaps in identifying 30 a company's role in furthering a relationship between company and customer.

Identifying 234 limitations include examining 268 a message transmitted from a business to a customer. A message is any information a company wants to tell a customer, such as price, product 12, the company's history, anything that is advertised, or any information that may be helpful in bringing a customer to the business. additionally, examining 270 a customer's expectation and examining 272 a customer's assessment of value associated with the transmitted message, was the message well received or discarded, are important to determining the customer's viewpoint and, by contrasting the results with examining 268 a transmitted message, a gap may be uncovered. In certain embodiments, to gain the customer's viewpoint, method 10 includes surveying 274 customers and/or surveying 276 a company's employees. Method 10 then identifies 278 differences between the customer's opinion, the business' employee's opinion, and the transmitted message.

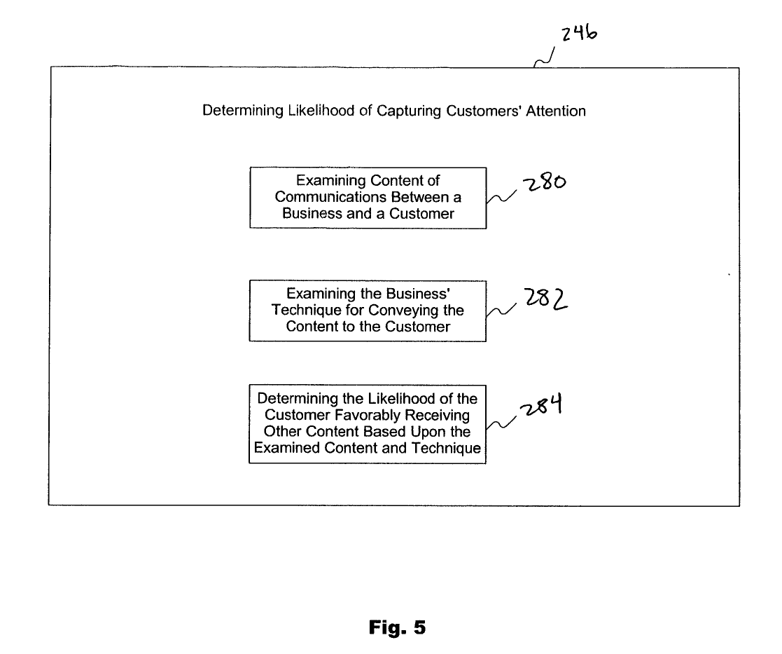

FIG. 5 more particularly depicts the step for determining 246 a likelihood of capturing a customer's attention, which further includes examining 280 the content of communications between a business and a customer, examining 282 the business' technique for conveying the content, and determining 284 a likelihood of the customer favorably receiving other content based upon the examined content and techniques.

Capturing a customer's attention is typically important to any marketing strategy because a customer that does not pay attention is an indication of failure, at least in part, of the marketing strategy. Determining 246 a likelihood of capturing the customer's attention, therefore, proves a needed element of any marketing strategy and for identifying 30 a company's role in furthering a company/customer relationship. Therefore, method 10 examines 280 content of what is being transmitted to the customer, such as price and adequate description of product 12. The technique for conveying the content, such as phone calls late at night, mailings with coupons and friendly advice, or internet spam mails, all affect the way customers react to the communication and contribute as much, if not more, to a favorable reception than the content.

Other areas to be considered include outside influences that draw attention away from the customer, such as personal problems, transportation problems, and work related issues, which all draw a customer's attention away from the business' communications.

Identifying 30 a company's role in furthering a relationship between the company and customer, including identifying an environment in which to market product 12, includes gathering and analyzing information related to the client company and competitors, if any. The nature of the market, the company, the customers, the targeted audiences, and the general climate of the market place all affect environment.

Identifying 30 a company's role in furthering a relationship between the company and customer includes examining the competitors, determining targeted audiences, learning how the market operates, and, generally, gathering and analyzing information to determine a likelihood of success product 12 will have in the environment. In addition, identifying 30 a company's role further includes an analysis of the company, its current customers, and potential customers.

Examining the competitors may involve a determination as to the extent of the market place currently covered by competitors' products. Large coverage of the market place by competitors may be a factor to consider when strategically practicing particular areas of business method 10, such as targeting an audience of customers different than initially anticipated. For example, if a business discovers that a competitor has a large extent of customers in the young male age group, one may then tailor his/her products to target an audience of older adults using business method 10 instead of targeting the young male population, which may prove too competitive for a new product.

Identifying 30 the business' role further includes identifying unique positions in a market that the business may occupy. This includes identifying voids in the market that a business believes it can fill. Finding and targeting voids in the market, or obtaining a unique position, is desirable because there are typically less, if any, competitors and customers are more easily obtained.

Identifying 30 the company's role further includes analyzing the company itself to determine its capacity to adapt to various market places. For example, if tooling is an expensive and lengthy process, the environment in which product 12 is to be marketed may be limited. If the company is merely a retail outlet for apparel, the environment in which product 12 is to be marketed may be broadened to include sporting gear, casual wear, and formal wear. Hence, an analysis of the company is a factor to be examined using method 10 in identifying the environment.

Identifying 30 the company's role further includes learning how the market operates, such as the manner in which a business generally operates in its industry. For example, online companies typically invest money to start up and this venture capital needs to be recouped before a profit is made. This differs from the way franchises operate, where a franchise may not need to obtain investors for a substantial portion of its start up costs. The franchiser may absorb a portion of the start up costs in exchange for royalties. Because one business may incur more initial costs than another business because of the nature of the market, one business may use a marketing strategy that is more aggressive than another business, whose operators may be under less stress to satisfy creditors. Therefore, the manner in which a market operates is a factor to be considered when identifying 30 the environment in which products are to be marketed.

Hence, method 10 takes into account the above mentioned factors when analyzing information for determining whether to market product 12 to a broad range of environments or limited to a sector of a specified marketing environment.

80 a value 212 of product 12 to customer 14, as shown in FIG. 1, comprises advertising, contacting customer 14, literature, salesperson, and other communications with prospective customers, such as a webpage or Internet location informing users of the value of product 12. The value of product 12 is defined to be a benefit or advantage of product 12 that is typically passed on or enjoyed by customer 14. Communicating 80 a value to the customer is for the purpose of enticing customer 14 to purchase product 12 so that he/she may enjoy the value, or benefit.

In certain embodiments and in addition to contacting customer 14, method 10 further includes contacting a third party for spreading the reputation of the company and/or furthering brand recognition. Third party includes, but is not limited to, another business, a peer, a colleague, a competitor, an employee, or an acquaintance.

Advertising includes placing advertisements in all known or novel mediums, such as television, radio, periodicals, newspapers, computer, or any manner for soliciting business from customers 14, which are both current and prospective customers.

Contact with customers includes direct contact, such as telemarketing, door to door selling, phone contact, or any other contact that is between the business and customer 14 without an entity between them, and indirect contact, such as a newspaper or television article or advertisement for communicating a value of the product.

Salesperson includes personnel communicating a product's value to customers. For example, a salesperson may make a presentation to an audience on the street corner, in a mall, or store in an attempt to entice customers to make a purchase. Salesperson further includes an orator making a speech or delivering a paper. The functions salesperson performs may overlap and/or be a combination of direct contact.

These components, among other components of communicating 80 a value of product 12, may be utilized and analyzed in any order and, hence, there is not a particular flow chart or pattern depicted.

The next step of method 10 is servicing 90 the customer. Servicing 90 comprises the transactions between customers 14 where currency changes hands in exchange for product 12. This is when the customer performs his/her contractual duties in exchange for product 12. Servicing 90 further comprises the actual sale, explaining warranty and/or return information to the customer, and answering questions surrounding the customer's performance of paying for product 12.

Reinforcing 120 the value of product 12 is for the purposes of creating loyalty by showing the customer, through customer service after the sale and performing the business' contractual duties, that he/she is not forgotten. Reinforcing 120 the value shows the customer that he/she made the right choice in purchasing product 12. Should product 12 be defective, honoring warranty/repair obligations corrects any doubts customer 14 may have about product 12 and, therefore, the value remains reinforced.

Moreover, reinforcing 120 the value fosters repeat customers and, ideally, new customers who have been referred by loyal or repeat customers. In certain embodiments, this includes communicating value to an employee and communicating value to third party. Hence, reinforcing 120 the value is an important step of method 10.

In addition, reinforcing 120 the value includes enhancing brand recognition. Brand recognition includes building good will among customers and exercising a business' trademark rights. When customers remember a particular brand or trademark and associate it with service after the sale, product value is reinforced. Customers, both current and prospective, then come to know a particular brand or trademark as having a particular quality and this is a goal of the step reinforcing 120 the value.

In certain embodiments, method 10 includes tracking current customers and prospective customers. Current customers may be tracked by the purchases they make. Prospective customers may be tracked by the inquiries they make via email or by their mailing addresses if they requested information to be sent to them. Tracking these customers is important for the varying types of communication. Current customers are valued and, in certain embodiments, coupons and other incentives are sent to them. Prospective customers who request specified information should be sent a broad range of information related to their inquiry sent. Sending information unrelated to their inquiry may be irritating and treated as mass mailing. Tracking, therefore, is an important step of method 10 for determining the types of communications with particular types of customers.

Method 10 uses the above mentioned steps in measuring a likelihood of success of a marketing strategy. Measuring includes polling and surveying, and any other known or novel manners for researching customers and noncustomers using the above mentioned manners for contacting people. Measuring further includes quantifying and qualifying results from the polls or surveys into useable reports to the client company.

In certain embodiments, such reports include categorizing most desirable to least desirable customers, demographics of various customers, ages of customers, or any other process for reporting results.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A method for providing an improved marketing strategy comprising the steps of:
providing a representation of how a business interacts with a customer;
identifying differences between existing content being transmitted to a customer and a customer's expectation; and
determining techniques a company uses to communicate to a customer.

2. The method according to claim 1, further comprising the step of determining limitations of communications between a business and a customer.

3. The method according to claim 1, further comprising the step of determining a likelihood of capturing a customer's attention.

4. The method according to claim 1, further comprising the step of surveying customers and prospective customers.

5. The method according to claim 1, further comprising the step of balancing measurable attributes with intangible attributes.

6. The method according to claim 1, further comprising the step of identifying strategic opportunities in order to determine the environment in which to market the product selected from the group consisting of communications, strategic imperatives, positioning evolutions, competitive mappings, target audiences, value opportunities, branding permissions, and brand attribute imperatives.

7. The method according to claim 1, further comprising the step of measuring a likelihood of success of the marketing strategy selected from the group consisting of polling, surveying, researching, qualifying, quantifying, and combinations thereof.

8. The method according to claim 1, further comprising the step of examining various levels of messaging and media for use in marketing communications.

9. The method according to claim 1, further comprising the step of developing a tracking system in order to identify prospective customers.

10. The method according to claim 1, further comprising the step of providing a representation of how a business interacts with a customer.

11. The method according to claim 1, further comprising the step of identifying differences between existing content being transmitted to a customer and a customer's expectation.

12. The method according to claim 1, wherein providing a representation of how a business interacts with a customer further comprises the steps of:
examining a business' operations;
examining a business' product being offered to a customer;
examining the customer's reaction to the business;
examining how the customer accesses the business; and
formulating a marketing strategy based upon the representation.

13. The method according to claim 1, wherein identifying differences between existing content being transmitted to a customer and a customer's expectation further comprises the steps of:
examining a message transmitted from a business to a customer;
examining a customer's expectation;
examining a customer's assessment of value associated with the transmitted message;
surveying a customer;
surveying a business' employee;
identifying differences between the customer's opinion, the business' employee's opinion, and the transmitted message; and
formulating a marketing strategy based upon the differences.

14. The method according to claim 1, further comprising the steps of:
examining content of communications between a business and a customer;
examining the business' technique for conveying the content to the customer; and
determining a likelihood of the customer favorably receiving other content based upon the examined content and technique.

15. A method for providing an improved marketing strategy comprising the steps of:
determining limitations of communications between a business and a customer;
determining a likelihood of capturing a customer's attention;
surveying customers and perspective customers;
balancing measurable attributes with intangible attributes; and
formulating a marketing strategy based upon the limitations, likelihood, survey, and balanced attributes.

16. The method according to claim 15, further comprising the step of providing a representation of how a business interacts with a customer.

17. The method according to claim 15, further comprising the step of identifying differences between existing content being transmitted to a customer and a customer's expectation.

18. The method according to claim 15, further comprising the step of determining techniques a company uses to communicate to a customer.

19. The method according to claim 15, wherein determining a likelihood of capturing a customer's attention further comprising the steps of:
examining content of communications between a business and a customer; and
examining the business' technique for conveying the content to the customer.

20. A method for providing an improved marketing strategy comprising the steps of:
providing a representation of how a business interacts with a customer;
identifying differences between existing content being transmitted to a customer and a customer's expectation;
determining techniques a company uses to communicate to a customer;
determining limitations of communications between a business and a customer;
determining a likelihood of capturing a customer's attention;
surveying customers and perspective customers;
balancing measurable attributes with intangible attributes; and
formulating a marketing strategy based upon the representation, differences, techniques, limitations, likelihood, survey, and balanced attributes.
